(19) United States
(12) Patent Application Publication
(10) Pub. No.: US 2025/0048392 A1
(43) Pub. Date: Feb. 6, 2025

(54) METHODS AND APPARATUSES FOR SIDELINK SLOT

(71) Applicant: Lenovo (Beijing) Limited, Beijing (CN)

(72) Inventors: Xin Guo, Beijing (CN); Haipeng Lei, Beijing (CN); Zhennian Sun, Beijing (CN); Xiaodong Yu, Beijing (CN)

(73) Assignee: Lenovo (Beijing) Limited, Beijing (CN)

(21) Appl. No.: 18/694,480

(22) PCT Filed: Sep. 24, 2021
(86) PCT No.: PCT/CN2021/120478

§ 371 Date: Mar. 22, 2024

(51) Int. Cl. H04W 72/25; H04W 72/0446; H04W 72/40

(52) U.S. Cl. CPC H04W 72/25; H04W 72/0446; H04W 72/40

(57) ABSTRACT

Methods and apparatuses for a sidelink slot providing more efficient data transmissions in 3GPP (3rd Generation Partnership Project) 5G networks. A UE includes a processor and a wireless transceiver coupled to the processor; and the processor of the UE is configured: to obtain configuration information regarding one or more sidelink slots, wherein each sidelink slot within the one or more sidelink slots includes multiple sets of symbols; and to transmit, via the wireless transceiver over a sidelink of the UE, using the one or more sidelink slots.

### TECHNICAL FIELD

Embodiments of the present application are related to wireless communication technology, and more particularly, related to methods and apparatuses for a sidelink slot providing more efficient data transmissions in wireless networks.

### BACKGROUND

A sidelink is a long-term evolution (LTE) feature introduced in 3GPP Release 12, and enables a direct communication between proximal UEs, and data does not need to go through a base station (BS) or a core network. A sidelink communication system has been introduced into 3GPP (3rd Generation Partnership Project) 5G wireless communication technology, in which a direct link between two user equipments (UEs) is called a sidelink (SL).

3GPP 5G networks are expected to increase network throughput, coverage and robustness and to reduce latency and power consumption. With the development of 3GPP 5G networks, various aspects need to be studied and developed to perfect the 5G technology. Currently, details regarding a sidelink slot for more efficient data transmissions have not been discussed in 3GPP 5G technology yet.

### SUMMARY

Some embodiments of the present application also provide a user equipment (UE). The UE includes a processor and a wireless transceiver coupled to the processor; and the processor is configured: to obtain configuration information regarding one or more sidelink slots, wherein each sidelink slot within the one or more sidelink slots includes multiple sets of symbols; and to transmit, via the wireless transceiver over a sidelink of the UE, using the one or more sidelink slots.

Some embodiments of the present application provide a method, which may be performed by a UE. The method includes: obtaining configuration information regarding one or more sidelink slots, wherein each sidelink slot within the one or more sidelink slots includes multiple sets of symbols; and transmitting over a sidelink of the UE, using the one or more sidelink slots.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE.

Some embodiments of the present application also provide a network node (e.g., a BS). The network node includes a processor and a wireless transceiver coupled to the processor; and the processor is configured: to transmit, via the wireless transceiver to a UE, configuration information regarding one or more sidelink slots, wherein each sidelink slot within the one or more sidelink slots includes multiple sets of symbols.

Some embodiments of the present application provide a method, which may be performed by a network node (e.g., a BS). The method includes: transmitting, to a UE, configuration information regarding one or more sidelink slots, wherein each sidelink slot within the one or more sidelink slots includes multiple sets of symbols.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a BS).

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates an exemplary sidelink wireless communication system in accordance with some embodiments of the present application;

FIG. 2 illustrates an exemplary sidelink slot according to some embodiments of the present application;

FIG. 3 illustrates an exemplary block diagram of an apparatus according to some embodiments of the present application;

FIG. 4 illustrates a flow chart of a method for obtaining configuration information regarding one or more sidelink slots according to some embodiments of the present application;

FIG. 5 illustrates a flow chart of a method for transmitting configuration information regarding one or more sidelink slots according to some embodiments of the present application;

FIG. 6 illustrates exemplary full symbols (FSs) according to some embodiments of the present application;

FIG. 7 illustrates exemplary half symbols (HSs) according to some embodiments of the present application;

FIG. 8 illustrates an exemplary extension of full symbols (FSs) according to some embodiments of the present application;

FIG. 9 illustrates exemplary combined symbols (CSs) according to some embodiments of the present application;

FIG. 10 illustrates an exemplary sidelink slot supporting a sub-slot without an extension of full symbols (FSs) according to some embodiments of the present application;

FIG. 11 illustrates a further exemplary sidelink slot supporting a sub-slot without an extension of full symbols (FSs) according to some embodiments of the present application;

FIG. 12 illustrates an exemplary sidelink slot supporting a sub-slot with an extension of full symbols (FSs) according to some embodiments of the present application; and

FIG. 13 illustrates an exemplary scheme for mapping PSSCH and/or PSCCH transmissions to a sub-slot resource within a sidelink slot according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

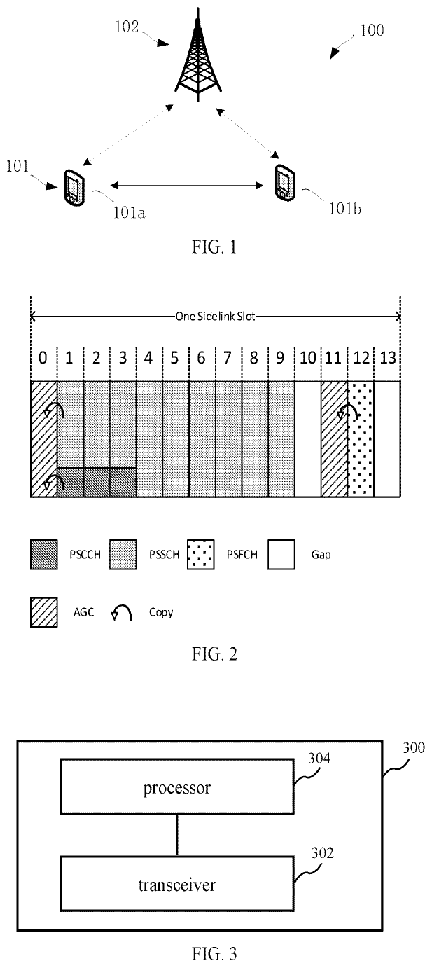

FIG. 1 illustrates an exemplary sidelink wireless communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface. Moreover, UE(s) 101 may work in a wider Internet-of-Thing (IoT) or Industrial IoT (IIoT) scenario with increased demand(s) of low air-interface latency and/or high reliability to be addressed, which includes such as factory automation, electrical power distribution, and/or transport industry.

In some embodiments of the present application, each of UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in UE(s) 101 may be varied and not limited.

In a sidelink communication system, a transmission ULE may also be named as a transmitting UE, a Tx UE, a sidelink Tx UE, a sidelink transmission UE, or the like. A reception UE may also be named as a receiving UE, a Rx UE, a sidelink Rx UE, a sidelink reception UE, or the like.

According to some embodiments of FIG. 1, UE 101a functions as a Tx UE, and UE 101b functions as a Rx UE. UE 101a may exchange sidelink messages with UE 101b through a sidelink, for example, PC5 interface as defined in 3GPP TS 23.303. UE 101a may transmit information or data to other UE(s) within the sidelink communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session.

Alternatively, according to some other embodiments of FIG. 1, UE 101b functions as a Tx UE and transmits sidelink messages, UE 101a functions as a Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

In general, supporting for a new radio (NR) SL is firstly introduced in 3GPP Rel-16. Although the resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication. Without loss of generality, this application only illustrates examples where all 14 OFDM symbols within a sidelink slot are available for sidelink communication. As per NR sidelink slot specified in 3GPP Rel-16, the first of the available OFDM symbols for sidelink communication of a sidelink slot is a copy of the second of the available OFDM symbols for sidelink communication of the sidelink slot; and the first of the available OFDM symbols for sidelink communication is used for an automatic gain control (AGC) purpose. The operation of AGC is performed by a UE when receiving a signal to determine the amplification degree, and thus, the UE can adjust the gain of the receiver amplifier to fit the power of the received signal. A specific example is shown in FIG. 2 as below.

FIG. 2 illustrates an exemplary sidelink slot according to some embodiments of the present application. As shown in FIG. 2, one sidelink slot includes 14 OFDM symbols in total, i.e., OFDM symbol #0 to OFDM symbol #13. OFDM symbol #0 is used for AGC by repeating the first OFDM symbol (i.e., OFDM symbol #1) carrying physical sidelink shared channel (PSSCH) and/or physical sidelink control channel (PSCCH) transmissions. The last available OFDM symbol, i.e., OFDM symbol #13, is always used as a guard symbol. In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol”, “a PSSCH and/or PSCCH symbol”, or the like.

In the embodiments of FIG. 2, if hybrid automatic repeat request (HARQ) feedback is enabled for the sidelink slot, a physical sidelink feedback channel (PSFCH) transmission is transmitted in the second last available OFDM symbol (i.e., OFDM symbol #12 as shown in FIG. 2) of the sidelink slot. An OFDM symbol carrying a PSFCH transmission may be named as “a PSFCH OFDM symbol”, “a PSFCH symbol”, or the like. One OFDM symbol right prior to the PSFCH symbol may be used as AGC and may comprise a copy of the PSFCH symbol. For example, OFDM symbol #11 as shown in FIG. 2 is used as AGC by repeating the PSFCH symbol #12 as shown in FIG. 2.

In some embodiments, a guard symbol between the PSSCH and/or PSCCH symbol and the PSFCH symbol is needed to provide switching time between “a PSSCH and/or PSCCH reception” and “a PSFCH transmission” (i.e., OFDM symbol #10 as shown in FIG. 2). This implies that, if PSFCH resources are configured for a sidelink slot, this will use a total of three OFDM symbols, including the AGC symbol and the extra guard symbol.

Considering that the AGC setting time occupies only 15 microseconds (i.e., see or s), and the assumption for the necessary transmission/reception (Tx/Rx) switching gap is 13 sec while the symbol duration for 15 kHz Subcarrier Spacing (SCS) is equal to 66.67 sec and the symbol duration for 30 kHz SCS is equal to 33.33 sec, it is inefficient to use a whole symbol working as AGC for some SCS, such as, 15 kHz or 30 kHz.

Currently, in a factory automation scenario, lower latency requirements are needed and thus cannot be satisfied by a slot-based sidelink transmission. For example, if SCSs are configured per a resource pool and if a desired resource pool is configured with a shorter SCS (such as, 15 kHz or 30 kHz), it is required to reduce the transmission latency for the configured SCS. This implies that, the latency on the resource pool cannot be reduced by applying a longer SCS. Therefore, an issue of “how to reduce the transmission latency while guaranteeing spectrum efficiency for a SCS configured in a resource pool” needs to be solved.

Embodiments of the present application propose a design of a sidelink slot, which can reduce transmission latency for a given SCS while guaranteeing spectrum efficiency. Embodiments of the present application can be applied to any SCS, such as, 15 kHz, 30 kHz, 60 kHz, 120 kHz, or 240 kHz, which is suitable for applying this disclosure. That is, the duration of a half-symbol is long enough for the corresponding Tx/Rx purposes. Embodiments of the present application can decrease the number of symbols carrying PSSCH and/or PSCCH transmissions, a PSSCH transmission and a PSFCH transmission within each sub-slot as much as possible.

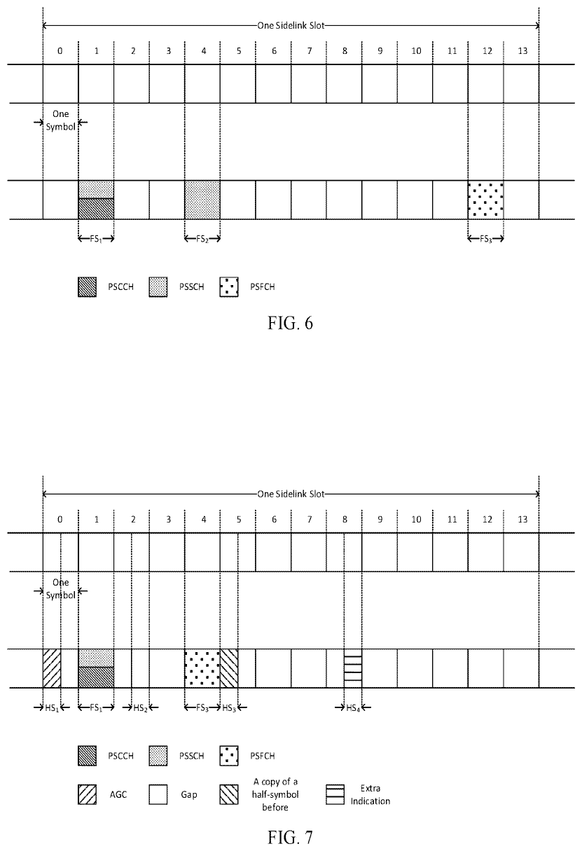

Some embodiments of the present application introduce sub-slot based sidelink slot design principles in supporting low latency and high spectrum efficiency sidelink transmission. Some embodiments of the present application provide two more types of half-symbol (HS) in supporting a flexible and efficient design of a sub-slot based sidelink slot, besides a half-symbol for AGC (e.g., HS₁ in the embodiments of FIG. 7) and a half-symbol for Tx/Rx switching (e.g., HS₂ in the embodiments of FIG. 7). Some embodiments of the present application define a combined symbol (CS) in supporting an efficient representation and configuration of a sub-slot based sidelink slot. Some embodiments of the present application define an extension of a full symbol (FS) for PSSCH and/or PSCCH transmissions or a PSFCH transmission, which could be located cross a boundary of an OFDM symbol and thus further decrease transmission latency. Some embodiments of the present application provide resource mapping of PSSCH and/or PSCCH transmissions to a sidelink sub-slot. In embodiments of the present application, a sidelink sub-slot refers to a fraction of a sidelink slot or a limited set of consecutive symbols within a sidelink slot. A sidelink sub-slot may also be named as “a sub-slot”, “a sidelink mini-slot”, “a mini-slot”, or the like. More details will be illustrated in following text in combination with the appended drawings.

FIG. 3 illustrates an exemplary block diagram of an apparatus according to some embodiments of the present application. As shown in FIG. 3, the apparatus 300 may include at least one processor 304 and at least one transceiver 302 coupled to the processor 304. The apparatus 300 may be a UE or a network node (e.g., a BS).

Although in this figure, elements such as the at least one transceiver 302 and the processor 304 are described in the singular, the plural is contemplated unless a limitation to the singular is explicitly stated. In some embodiments of the present application, the transceiver 302 may be divided into two devices, such as a receiving circuitry and a transmitting circuitry. In some embodiments of the present application, the apparatus 300 may further include an input device, a memory, and/or other components.

In some embodiments of the present application, the apparatus 300 may be a UE (e.g., UE 101a or UE 101b illustrated and shown in FIG. 1). For instance, the UE is a Tx UE (e.g., UE 101a illustrated and shown in FIG. 1). The processor 304 of the UE may be configured: to obtain configuration information regarding one or more sidelink slots, wherein each sidelink slot within the one or more sidelink slots may include multiple sets of symbols; and to transmit, via the wireless transceiver over a sidelink of the UE, using the one or more sidelink slots. For example, the processor 304 of the UE may be configured to transmit, via the wireless transceiver over the sidelink of the UE, using one of the one or more sidelink slots at one time instance.

For instance, the configuration information may be obtained from a network node (e.g., a BS, which may be BS 102 illustrated and shown in FIG. 1) or be pre-configured in the UE. In case of the configuration information obtained from a network node, the configuration information can be transmitted via system information block (SIB), master information block (MIB), radio resource control (RRC) signaling, a medium access control (MAC) control element (CE), or downlink control information (DCI).

In some embodiments of the present application, the apparatus 300 may be a network node (e.g., a BS, which may be BS 102 illustrated and shown in FIG. 1). The transceiver 302 in the network node may be configured to transmit, to a UE (e.g., a Tx UE, which may be UE 101a illustrated and shown in FIG. 1), configuration information regarding one or more sidelink slots, wherein each sidelink slot within the one or more sidelink slots includes multiple sets of symbols.

According to some embodiments, the configuration information regarding the one or more sidelink slots is associated with a resource pool, a zone, or a frequency band (such as FR1 or FR2). In an example, if the configuration information is associated with a resource pool, sidelink slot related information may be included in resource pool configuration information. In another example, if the configuration information is associated with a zone, sidelink slot related information may be included in zone configuration information. A zone is the division of geographical area.

According to some embodiments, the configuration information regarding the one or more sidelink slots includes: a list of information element(s); and a total number of the one or more sidelink slots. Each information element (IE) in the list may be associated with one sidelink slot within the one or more sidelink slots. According to some embodiments, each IE in the list includes at least one of:
(1) An identifier (ID) of one sidelink slot within the one or more sidelink slots.
(2) A slot pattern ID of the one sidelink slot. For example, if two or more slot patterns are configured for the one sidelink slot, each IE in the list may include the slot pattern ID. A slot pattern may also be named as “a slot format” or the like.
(3) A further list of IE(s) associated with one or more symbols within the one sidelink slot. For example, the further list includes a total number of the one or more symbols. Each IE in the further list may include an ID of one symbol within the one or more symbols.

In some embodiments, each symbol within the one or more symbols may be: (1) a full symbol (FS); (2) a half symbol (HS); or (3) a combined symbol (CS). The CS may comprise two half symbols with different types. Specific examples are described in Embodiments 1-3 as follows.

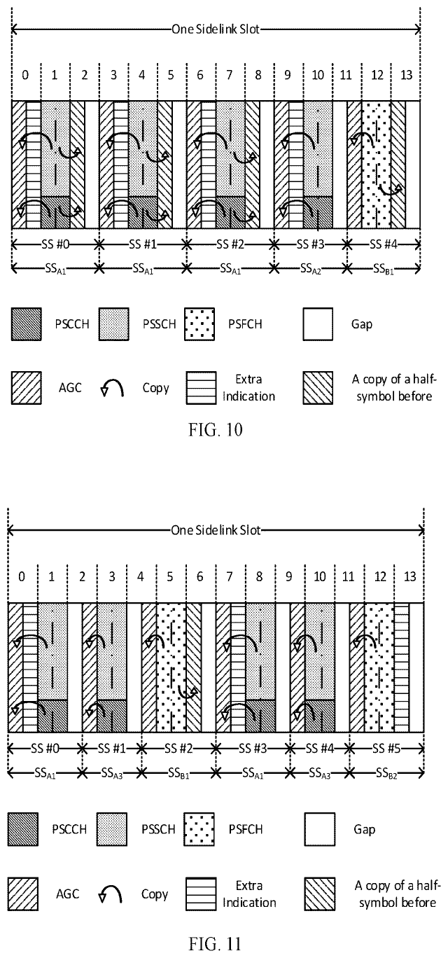

In some embodiments, each sidelink slot within the one or more sidelink slots includes one or more sub-slots, and each set within the multiple sets of symbols corresponds to one sub-slot. A sub-slot may include: a full symbol (FS); a half symbol (HS); and/or a combined symbol (CS). The CS may comprise two half symbols with different types. Specific examples of a CS are described in embodiments of FIG. 9 as follows.

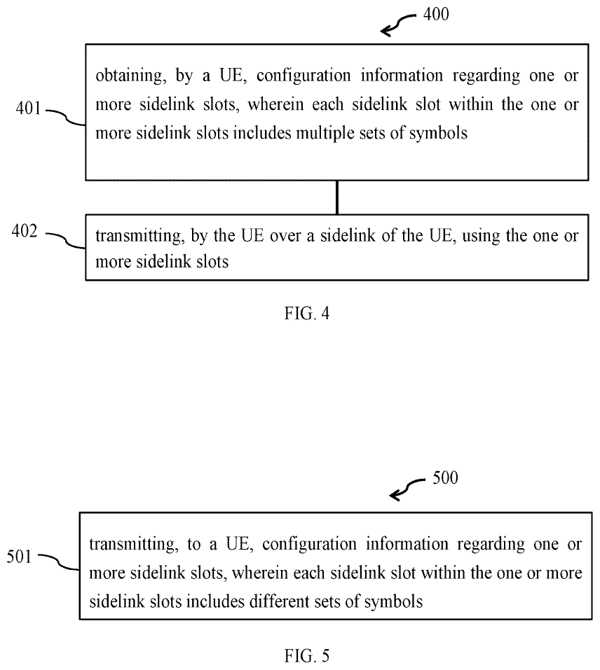

In some embodiments, a full symbol includes: (1) a PSSCH transmission and a PSCCH transmission; (2) another PSSCH transmission; or (3) a PSFCH transmission. In some embodiments, a length of a full symbol is equal to a length of an OFDM symbol in time domain. A starting point of the full symbol may be aligned with “a starting point of an OFDM symbol” or “a starting point of a second half of an OFDM symbol”. Specific examples of a FS are described in embodiments of FIGS. 5-8 and 12 as follows.

In an embodiment, if a starting point of a full symbol is aligned with a starting point of an OFDM symbol, a sub-slot may include: at least one full symbol; at most two half symbols; and/or at least one combined symbol.

In a further embodiment, if a starting point of a full symbol is aligned with a starting point of a second half of an OFDM symbol, a sub-slot may include at least one full symbol and/or at least one half symbol.

In some embodiments, a sub-slot may include a start half symbol and an end half symbol. For example, in a sub-slot (e.g., SS #0 in the embodiments of FIG. 10), a start half symbol (e.g., HS₁ in the embodiments of FIG. 7) may include a copy of a first half of a full symbol after the start half symbol in time domain; and an end half symbol (e.g., HS₂ in the embodiments of FIG. 7) may include a switching gap in time domain between a transmission operation of the UE and a reception operation of the UE.

In some embodiments, a half symbol (e.g., HS₁ in the embodiments of FIG. 7) includes a copy of a first half of a full symbol after the half symbol in time domain. For example, this full symbol after the half symbol may carry “a PSSCH transmission and a PSCCH transmission” or “another PSSCH transmission” or “a PSFCH transmission”.

In some other embodiments, a half symbol (e.g., HS₃ in the embodiments of FIG. 7) includes a copy of a second half of a full symbol before the half symbol in time domain. For example, this full symbol before the half symbol may carry “a PSSCH transmission and a PSCCH transmission” or “another PSSCH transmission” or “a PSFCH transmission”.

In some further embodiments, a half symbol (e.g., HS₂ in the embodiments of FIG. 7) includes a switching gap in time domain between a transmission operation of the UE and a reception operation of the UE. In some additional embodiments, a half symbol (e.g., HS₄ in the embodiments of FIG. 7) includes information associated with a preamble sequence.

According to some embodiments, a length of a combined symbol is equal to a length of an OFDM symbol in time domain. There may be following four types of combined symbols.

In some embodiments, a 1st type of combined symbol (e.g., CS₁ in the embodiments of FIG. 9) includes “a first half symbol which is set as a 1st type of half symbol” and “a second half symbol which is set as a 4th type of half symbol”. The 1st type of half symbol (e.g., HS₁ in the embodiments of FIG. 7) includes a copy of a first half of a symbol after the 1st type of half symbol in time domain. The 4th type of half symbol (e.g., HS₄ in the embodiments of FIG. 7) includes information associated with a preamble sequence.

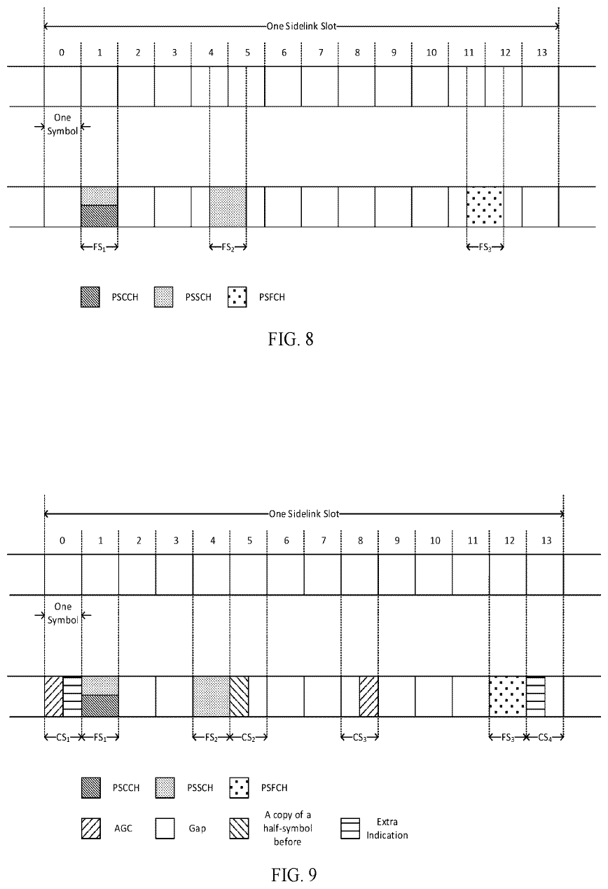

In some embodiments, a 2nd type of combined symbol (e.g., CS₂ in the embodiments of FIG. 8) includes “a first half symbol which is set as a 3rd type of half symbol” and “a second half symbol which is set as a 2nd type of half symbol”. The 3rd type of half symbol (e.g., HS₃ in the embodiments of FIG. 7) includes a copy of a second half of a symbol before the 3rd type of half symbol in time domain. The 2nd type of half symbol (e.g., HS₂ in the embodiments of FIG. 7) includes a switching gap in time domain between a reception operation of the UE and a transmission operation of the UE.

In some embodiments, a 3rd type of combined symbol (e.g., CS3 in the embodiments of FIG. 8) includes “a first half symbol which is set as the 2nd type of half symbol (e.g., HS₂ in the embodiments of FIG. 7)” and “a second half symbol which is set as the 1st type of half symbol (e.g., HS₁ in the embodiments of FIG. 7)”.

In some embodiments, a 4th type of combined symbol (e.g., CS4 in the embodiments of FIG. 8) includes “a first half symbol which is set as the 4th type of half symbol (e.g., HS₄ in the embodiments of FIG. 7)” and “the second half symbol which is set as the 2nd type of half symbol (e.g., HS₂ in the embodiments of FIG. 7)”.

In some embodiments, there may be two types of sub-slots. A 1st type of sub-slot may include one or more symbols carrying at least a PSSCH transmission and a PSCCH transmission. A 2nd type of sub-slot may comprise one or more symbols carrying a PSFCH transmission.

In some embodiments, a sub-slot is consecutive in time domain. In some embodiments, a sub-slot may carry 1st-stage sidelink control information (SCI), 2^{nd}-stage SCI, and/or sidelink data. For example, in frequency domain, the 1st-stage SCI may be mapped to start from a lowest frequency position of a start symbol carrying at least a PSSCH transmission and a PSCCH transmission in the sub-slot within the one or more sub-slots, and the 1st-stage SCI may be mapped with a bandwidth satisfying transmission requirement of the 1st-stage SC. In frequency domain, the 2^{nd}-stage SCI may be mapped to start from an end frequency position of the 1^{st}-stage SCI, and the 2^{nd}-stage SCI may be mapped with a bandwidth satisfying transmission requirement of the 2^{nd}-stage SCI. In frequency domain, the sidelink data may be mapped to the remaining resources starting from an end frequency position of the 2^{nd}-stage SCI.

In some embodiments of the present application, the apparatus 300 may further include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 304 interacting with the transceiver 302, so as to perform operations of the methods, e.g., as described in view of FIGS. 4-13.

FIG. 4 illustrates a flow chart of a method for obtaining configuration information regarding one or more sidelink slots according to some embodiments of the present application. The embodiments of FIG. 4 may be performed by a UE (e.g., UE 101a or UE 101b illustrated and shown in FIG. 1). Although described with respect to a UE, it should be understood that other devices may be configured to perform a method similar to that of FIG. 4.

In the exemplary method 400 as shown in FIG. 4, in operation 401, a UE (e.g., UE 101a illustrated and shown in FIG. 1) obtains configuration information regarding one or more sidelink slots. For example, the configuration information may be obtained from a network node (e.g., a BS, which may be BS 102 illustrated and shown in FIG. 1) or be pre-configured in the UE. Each sidelink slot within the one or more sidelink slots may include multiple sets of symbols. Each set within the multiple sets of symbols may correspond to one sub-slot. A sub-slot may include: a full symbol (FS); a half symbol (HS); and/or a combined symbol (CS). In operation 402, the UE transmits over a sidelink of the UE, using the one or more sidelink slots.

It is contemplated that the method illustrated in FIG. 4 may include other operation(s) not shown, for example, any operation(s) described with respect to FIGS. 3 and 5-13.

Details described in all other embodiments of the present application (for example, details regarding a sidelink slot) are applicable for the embodiments of FIG. 4. Moreover, details described in the embodiments of FIG. 4 are applicable for all embodiments of FIGS. 3 and 5-13.

FIG. 5 illustrates a flow chart of a method for transmitting configuration information regarding one or more sidelink slots according to some embodiments of the present application. The embodiments of FIG. 5 may be performed by a network node (e.g., a BS, which may be BS 102 illustrated and shown in FIG. 1). Although described with respect to a network node, it should be understood that other devices may be configured to perform a method similar to that of FIG. 5.

In the exemplary method 500 as shown in FIG. 5, in operation 501, a network node (e.g., BS 102 illustrated and shown in FIG. 1) transmits, to a UE (e.g., UE 101a illustrated and shown in FIG. 1), configuration information regarding one or more sidelink slots, wherein each sidelink slot within the one or more sidelink slots includes multiple sets of symbols. Each set within the multiple sets of symbols may correspond to one sub-slot. A sub-slot may include: a full symbol (FS); a half symbol (HS); and/or a combined symbol (CS).

It is contemplated that the method illustrated in FIG. 5 may include other operation(s) not shown, for example, any operation(s) described with respect to FIGS. 3, 4, and 6-13.

Details described in all other embodiments of the present application (for example, details of configuration information regarding sidelink slot(s)) are applicable for the embodiments of FIG. 5. Moreover, details described in the embodiments of FIG. 5 are applicable for all embodiments of FIGS. 3, 4, and 6-13.

Some embodiments of the present application introduce a definition of “a full symbol (FS)” which is relative to sub-slot based sidelink slot. A FS may be defined as being aligned in time domain with an OFDM symbol as specified in 3GPP standard documents. For instance, there may be following three types of full symbols:
(1) FS₁ is defined as a full symbol which is for carrying PSSCH and/or PSCCH transmissions;
(2) FS₂ is defined as a full symbol which is for carrying a PSSCH transmission; and
(3) FS₃ is defined as a full symbol which is for carrying a PSFCH transmission.

FIG. 6 illustrates exemplary full symbols (FSs) according to some embodiments of the present application. The same as FIG. 2, in the embodiments of FIG. 6, one sidelink slot includes 14 OFDM symbols in total, i.e., OFDM symbol #0 to OFDM symbol #13. As illustrated by FIG. 6, OFDM symbol #1 is a full symbol, labeled as FS₁, which is for carrying PSSCH and/or PSCCH transmissions; OFDM symbol #4 is a full symbol, labeled as FS₂, which is for carrying a PSSCH transmission; and OFDM symbol #12 is a full symbol, labeled as FS₃, which is for carrying a PSFCH transmission.

Some embodiments of the present application introduce a definition of “a half symbol (HS)” which is relative to sub-slot based sidelink slot. A HS may be defined as the first half or the second half of an OFDM symbol as specified in 3GPP standard documents. For instance, there may be following four types of half symbols:
(1) HS₁ is defined as a HS which is “a copy of the first half of the nearest PSSCH and/or PSCCH symbol after the HS” or “a copy of the first half of the nearest PSFCH symbol after the HS”. For example, HS₁ can be used as AGC.
(2) HS₂ is defined as a HS which works as a gap for Tx/Rx switching.
(3) HS₃ is defined as a HS which is “a copy of the second half of the nearest PSSCH and/or PSCCH symbol before the HS” or “a copy of the second half of the nearest PSFCH symbol before the HS”. For example, HS₃ can be used for reliability improvement.
(4) HS₄ is defined as a HS carrying extra information by transmitting a preamble sequence. The information carried in HS₄ can be used for supporting a sub-slot based transmission. For example, HS₄ can be used for increasing spectrum efficiency. Or, HS₄ can be used for padding a symbol.

FIG. 7 illustrates exemplary half symbols (HSs) according to some embodiments of the present application. The same as FIGS. 2 and 6, in the embodiments of FIG. 7, one sidelink slot includes 14 OFDM symbols in total, i.e., OFDM symbol #0 to OFDM symbol #13.

As illustrated by FIG. 7, OFDM symbol #1 is a full symbol, labeled as FS₁, which is for carrying PSSCH and/or PSCCH transmissions. The first half of OFDM symbol #0 is a half symbol, labeled as HS₁, which is a copy of the first half of the PSSCH and/or PSCCH symbol in FS₁. HS₁ may be used as AGC. OFDM symbol #4 is a full symbol of FS₃, which is for carrying a PSFCH transmission. The second half of OFDM symbol #2 is a half symbol of HS₂, which works as gap for Tx/Rx switching. The first half of OFDM symbol #5 is a half symbol of HS₃, which is a copy of the second half of the PSFCH symbol in FS₃. The second half of OFDM symbol #8 is a half symbol of HS₄, which is for carrying extra information by a preamble sequence.

In some embodiments of the present application, a FS can be defined as having a length of an OFDM symbol. Without an extension, a starting point of a FS may be aligned only with a starting point of an OFDM symbol. With an extension, a starting point of a FS may be aligned either with a starting point of an OFDM symbol or with a starting point of a second half of an OFDM symbol. For instance, a FS may be used to carry PSSCH and/or PSCCH transmissions, a PSSCH transmission, or a PSFCH transmission, as illustrated by FIG. 8.

FIG. 8 illustrates an exemplary extension of full symbols (FSs) according to some embodiments of the present application. The same as FIGS. 2, 6, and 7, in the embodiments of FIG. 8, one sidelink slot includes 14 OFDM symbols in total, i.e., OFDM symbol #0 to OFDM symbol #13.

As illustrated by FIG. 8, the starting point of FS₁ is aligned with the starting point of OFDM symbol #1. The starting point of FS₂ is aligned with the starting point of the second half of OFDM symbol #4. The ending point of FS₂ is aligned with the starting point of the second half of OFDM symbol #5. The starting point of FS₃ is aligned with the starting point of the second half of OFDM symbol #11. The ending point of FS₃ is aligned with the starting point of the second half of OFDM symbol #12.

Some embodiments of the present application introduce a definition of “a combined symbol (CS)” relative to sub-slot based sidelink slot. A CS may be defined as having a length of a symbol in time domain and comprising two different types of half-symbols.

For four different types of half-symbols, i.e., HS₁, HS₂, HS₃, HS₄ as described above, there could be twelve types of combined symbols (CSs) in total according to the definition of a CS. For example, with considerations for a sidelink slot design, there may be following four types of CSs, as illustrated in FIG. 9:
(1) CS₁: The first half of the combined symbol is HS₁, and the second half of the combined symbol is HS₄.
(2) CS₂: The first half of the combined symbol is HS₃, and the second half of the combined symbol is HS₂.
(3) CS₃: The first half of the combined symbol is HS₂, and the second half of the combined symbol is HS₁.
(4) CS₄: The first half of the combined symbol is HS₄, and the second half of the combined symbol is HS₂.

For enhancing spectrum efficiency, CS₁ and CS₄ can be used for shortening the time duration for AGC/Gap and using the rest time of the symbol transmitting assistance information. For improving reliability, HS₃ in CS₂ can be used to improve transmission reliability for a previous full symbol when being deployed right after a symbol carrying PSSCH and/or PSCCH transmissions, a symbol carrying a PSSCH transmission, or a symbol carrying a PSFCH transmission.

FIG. 9 illustrates exemplary combined symbols (CSs) according to some embodiments of the present application. The same as FIGS. 2 and 6-8, in the embodiments of FIG. 9, one sidelink slot includes 14 OFDM symbols in total, i.e., OFDM symbol #0 to OFDM symbol #13.

As illustrated by FIG. 9, CS₁ comprises two HSs as shown in OFDM symbol #0, i.e., the first half of the combined symbol is HS₁, and the second half of the combined symbol is HS₄. The starting point of FS₁ is aligned with the starting point of OFDM symbol #1. The starting point of FS₂ is aligned with the starting point of OFDM symbol #4. CS₂ comprises two HSs as shown in OFDM symbol #5, i.e., the first half of the combined symbol is HS₃ and the second half of the combined symbol is HS₂. CS₃ comprises two HSs as shown in OFDM symbol #8, i.e., the first half of the combined symbol is HS₂ and the second half of the combined symbol is HS₁. The starting point of FS₃ is aligned with the starting point of OFDM symbol #12. CS₄ comprises two HSs as shown in OFDM symbol #13, i.e., the first half of the combined symbol for is HS₄ and the second half of the combined symbol is HS₂.

Some embodiments of the present application introduce different types of sidelink sub-slots. According to some embodiments, a sidelink sub-slot (SS) can be defined according to without or with an extension of a FS as follows.

Without an extension of a FS, a SS may be defined as satisfying at least following features:
(1) being consecutive in the time domain within a sidelink slot;
(2) comprising at least one full symbol of PSSCH and/or PSCCH or PSFCH;
(3) comprising at least one combined symbol;
(4) comprising at most two half-symbols; and
(5) starting with HS₁ and ending up with HS₂.

With an extension of a FS, a SS may be defined as satisfying at least following features:
(1) being consecutive in the time domain within a sidelink slot;
(2) comprising at least one full symbol of PSSCH and/or PSCCH or PSFCH;
(3) comprising at least one half-symbol; and
(4) starting with HS₁ and ending up with HS₂.

According to some embodiments, sidelink sub-slots can be categorized into two types according to whether the sidelink sub-slots carrying PSSCH and/or PSCCH transmissions or carrying a PSFCH transmission. These two types of sidelink sub-slots may be defined as:
(1) Sub-slot type SS_{A} which does not comprise symbol(s) of a PSFCH transmission. That is, SS_{A} comprises only “PSSCH and/or PSCCH transmissions” or only “a PSSCH transmission”.
(2) Sub-slot type SS_{B} which does not comprise symbol(s) of PSSCH and/or PSCCH transmissions. That is, SS_{B} comprises only a PSFCH transmission.

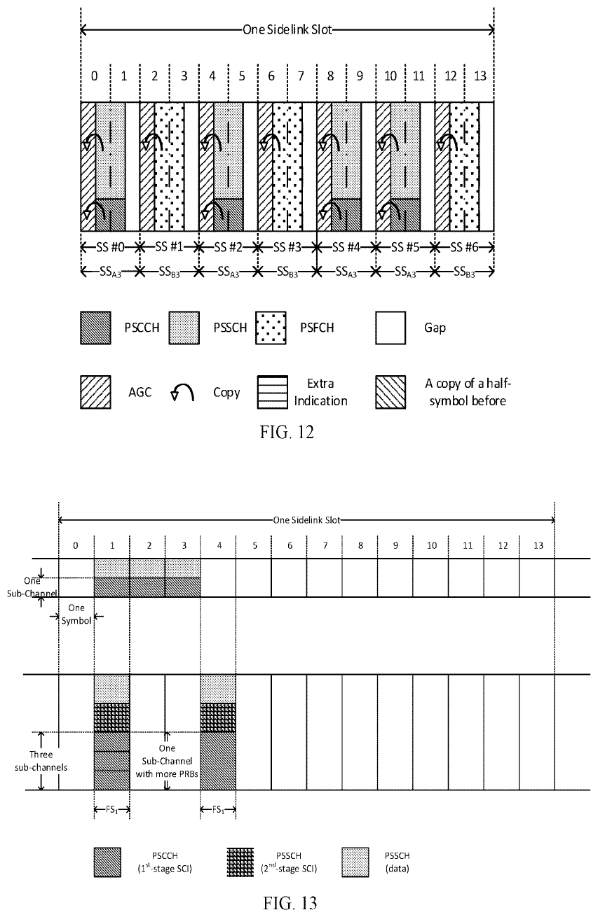

According to some embodiments, sub-slot type SS_{A} can be further classified as follows:
(1) Sub-slot type SS_{A1} which comprises one CS₁, at least one FS₁, and one CS₂. For example, SS #0 as shown in FIG. 10 belongs to sub-slot type SS_{A1}.
(2) Sub-slot type SS_{A2} which comprises one CS₁, at least one FS₁, and one HS₂. For example, SS #3 as shown in FIG. 10 belongs to sub-slot type SS_{A2}.
(3) Sub-slot type SS_{A3} which comprises one HS₁, at least one FS₁, and one HS₂. For example, SS #1 as shown in FIG. 11 or SS #0 as shown in FIG. 12 belongs to sub-slot type SS_{A3}. The difference is that the sidelink slot in FIG. 10 does not support an extension of a FS, while the sidelink slot in FIG. 12 supports an extension of a FS.

According to some embodiments, sub-slot type SS_{B} can be further classified as follows:
(1) Sub-slot type SS_{B1} which comprises one HS₁, at least one FS₃, and one CS₂. For example, SS #4 in FIG. 10 belongs to sub-slot type SS_{B1}.
(2) Sub-slot type SS_{B2} which comprises one HS₁, at least one FS₃, and one CS₄. For example, SS #5 in FIG. 11 belongs to sub-slot type SS_{B2}.
(3) Sub-slot type SS_{B3} which comprises one HS₁, at least one FS₃, and one HS₂. For example, SS #1 in FIG. 12 belongs to sub-slot type SS_{B3}. The sidelink slot in FIG. 12 supports an extension of a FS.

FIG. 10 illustrates an exemplary sidelink slot supporting a sub-slot without an extension of full symbols (FSs) according to some embodiments of the present application. The same as FIGS. 2 and 6-9, in the embodiments of FIG. 10, one sidelink slot includes 14 OFDM symbols in total, i.e., OFDM symbol #0 to OFDM symbol #13.

In the embodiments of FIG. 10, the sidelink slot as illustrated by FIG. 10 includes five sidelink sub-slots in total, i.e., SS #0, SS #1, SS #2, SS #3, and SS #4. All of SS #0, SS #1, and SS #2 belong to sub-slot type SS_{A1}, which comprises one CS₁, one FS₁ and one CS₂. SS #3 belongs to sub-slot type SS_{A2}, which comprises one CS₁, one FS₁ and one HS₂. SS #4 belongs to sub-slot type SS_{B1}, which comprises one HS₁, one FS₃ and one CS₂.

FIG. 11 illustrates a further exemplary sidelink slot supporting a sub-slot without an extension of full symbols (FSs) according to some embodiments of the present application. The same as FIGS. 2 and 6-10, in the embodiments of FIG. 11, one sidelink slot includes 14 OFDM symbols in total, i.e., OFDM symbol #0 to OFDM symbol #13.

In the embodiments of FIG. 11, the sidelink slot as illustrated by FIG. 11 includes six sidelink sub-slots in total, i.e., SS #0, SS #1, SS #2, SS #3, SS #4, and SS #5. Both SS #0 and SS #3 belong to sub-slot type SS_{A1}, which comprises one CS₁, one FS₁ and one CS₂. Both SS #1 and SS #4 belong to sub-slot type SS_{A3}, which comprises one HS₁, one FS₁ and one HS₂. SS #2 belongs to sub-slot type SS_{B1}, which comprises one HS₁, one FS₃ and one CS₂. SS #5 belongs to sub-slot type SS_{B2}, which comprises one HS₁, one FS₃ and one CS₄. In the embodiments of FIG. 11, CS3 is used to concatenate two adjacent sub-slots as illustrated by OFDM symbol #2 in FIG. 11.

FIG. 12 illustrates an exemplary sidelink slot supporting a sub-slot with an extension of full symbols (FSs) according to some embodiments of the present application. The same as FIGS. 2 and 6-11, in the embodiments of FIG. 12, one sidelink slot includes 14 OFDM symbols in total, i.e., OFDM symbol #0 to OFDM symbol #13.

In the embodiments of FIG. 12, the sidelink slot as illustrated by FIG. 12 includes seven sidelink sub-slots in total, i.e., SS #0, SS #1, SS #2, SS #3, SS #4, SS #5, and SS #6. All of SS #0, SS #2, SS #4, and SS #5 belong to sub-slot type SS_{A3}, which comprises one HS₁, one FS₁ and one HS₂. All of SS #1, SS #3, and SS #6 belong to sub-slot type SS_{B3}, which comprises one HS₁, one FS₃ and one HS₂.

According to some embodiments, resources in frequency domain are increased, such that they are enough for PSCCH transmission(s) within one OFDM symbol, which can be realized by:
(1) increasing a total number of physical resource blocks (PRBs) within each sub-channel (e.g., FS₁ corresponding to OFDM symbol #4 as illustrated by FIG. 13); or
(2) increasing a total number of sub-channels for a PSCCH transmission within one OFDM symbol (e.g., FS₁ corresponding to OFDM symbol #1 as illustrated by FIG. 13).

FIG. 13 illustrates an exemplary scheme for mapping PSSCH and/or PSCCH transmissions to a sub-slot resource within a sidelink slot according to some embodiments of the present application. The same as FIGS. 2 and 6-12, in the embodiments of FIG. 13, one sidelink slot includes 14 OFDM symbols in total, i.e., OFDM symbol #0 to OFDM symbol #13.

In the embodiments of FIG. 13, 1^{st}-stage SCI is transmitted from the first OFDM symbol carrying PSSCH and/or PSCCH transmissions within the sidelink sub-slot as illustrated by FIG. 13. The 1st-stage SCI is mapped from a lowest frequency position of the first OFDM symbol carrying PSSCH and/or PSCCH transmissions. Then, the 2^{nd}-stage SCI is mapped from the end position of the 1^{st}-stage SCI, and data is mapped from the end position of the 2^{nd}-stage SCI.

In particular, in FS₁ corresponding to OFDM symbol #1 as illustrated by FIG. 13, in frequency domain, the 1st-stage SCI is mapped to start from a lowest frequency position of the symbol and is mapped with a bandwidth of three sub-channels for carrying a PSCCH transmission; the 2^{nd}-stage SCI is mapped to start from the end position of the 1^{st}-stage SCI and the 2^{nd}-stage SCI is mapped to a PSSCH transmission; and data is mapped to start from the end position of the 2^{nd}-stage SCI and the data is mapped to a PSSCH transmission.

In FS₁ corresponding to OFDM symbol #4 as illustrated by FIG. 13, in frequency domain, the 1st-stage SCI is mapped to start from a lowest frequency position of the symbol and is mapped with a bandwidth of one sub-channel with more PRBs for carrying a PSCCH transmission; the 2^{nd}-stage SCI is mapped to start from the end position of the 1^{st}-stage SCI and the 2^{nd}-stage SCI is mapped to a PSSCH transmission; and data is mapped to start from the end position of the 2^{nd}-stage SCI and the data is mapped to a PSSCH transmission.

The following texts describe specific Embodiments 1-3 of the methods of constructing a sidelink slot as shown and illustrated in FIGS. 3-13. When multiple sidelink slots are configured, there could be a sidelink slot ID indicating a sidelink slot from other sidelink slot(s).

### Embodiment 1

In Embodiment 1, a sidelink slot can be constructed and indicated by an orderly set of symbols. The orderly set of symbols does not support an extension of a FS. Each symbol in the orderly set of symbols could be a full symbol or a combined symbol. Each symbol in the orderly set of symbols may be indicated by a numbering corresponding to its symbol type. An example mapping of symbol type numbering and symbol type is illustrated by following exemplary Table 1.

The symbols within a sidelink slot are sorted orderly in the orderly set of symbols. An example of an orderly set of symbols corresponding to slot configuration illustrated by the embodiments of FIG. 10 is (3, 0, 4, 3, 0, 4, 3, 0, 4, 3, 0, 5, 2, 4).

In Embodiment 1, sidelink slot information may comprise “representation and description of symbols” and “representation and description of an orderly set of symbols”.

### Embodiment 2

In Embodiment 2, a sidelink slot can be constructed and indicated by using an orderly set of half-symbols and/or symbols. The orderly set of half-symbols and/or symbols supports an extension of a FS. Each component in the orderly set could be half symbol, full symbol or combined symbol. Each component in the orderly set is indicated by a numbering corresponding to its type. The half-symbol and/or symbol within a sidelink slot are sorted orderly in the orderly set of half-symbols and/or symbols. An example mapping of half-symbol and/or symbol type numbering and half-symbol and/or symbol type is illustrated by following exemplary Table 2.

### Embodiment 3

In Embodiment 3, a sidelink slot can be constructed and indicated by using an orderly set of sub-slots. Each sub-slot is indicated by a numbering corresponding to its sub-slot type. The sub-slots within a sidelink slot are sorted orderly in the orderly set of sub-slots. Each sub-slot can be further configured by Embodiment 1 or Embodiment 2.

TABLE 1
representations and descriptions of symbols within
a sidelink slot associated with Embodiment 1

| | Symbol | Symbol Type |
|---|---|---|
| Symbol ID | Type Index | Description |
| 0 | FS₁ | A full symbol for PSSCH and/ |
| | | or PSCCH transmission |
| 1 | FS₂ | A full symbol for PSSCH transmission |
| 2 | FS₃ | A full symbol for PSFCH transmission |
| 3 | CS₁ | A combined symbol in which the first half |
| | | of the combined symbol is HS₁, |
| | | and the second half of the |
| | | combined symbol is HS₄ |
| 4 | CS₂ | A combined symbol in which the first half |
| | | of the combined symbol is HS₃, |
| | | and the second half of the |
| | | combined symbol is HS₂ |
| 5 | CS₃ | A combined symbol in which the first half |
| | | of the combined symbol is HS₂, |
| | | and the second half of the |
| | | combined symbol is HS₁ |
| 6 | CS₄ | A combined symbol in which the first half |
| | | of the combined symbol is HS₄, |
| | | and the second half of the |
| | | combined symbol is HS₂ |

TABLE 2
representations and descriptions of symbols within
a sidelink slot associated with Embodiment 2

| | Symbol | Symbol Type |
|---|---|---|
| Symbol ID | Type Index | Description |
| 0 | HS₁ | a HS which is a copy of (the |
| | | first half of) the nearest |
| | | PSSCH and/or PSCCH or |
| | | PSFCH symbol after the HS |
| 1 | HS₂ | a HS which works as gap |
| | | for Tx/Rx switching |
| 2 | HS₃ | a HS which is a copy of |
| | | (the second half of) the nearest |
| | | PSSCH and/or PSCCH or PSFCH |
| | | symbol before the HS |
| 3 | HS₄ | a HS conveying extra information by |
| | | transmitting a preamble sequence |
| 4 | FS₁ | An extension of full symbol for |
| | | PSSCH and/or PSSCH PSCCH transmission |
| 5 | FS₂ | An extension of full symbol |
| | | for PSSCH transmission |
| 6 | FS₃ | An extension of full symbol |
| | | for PSFCH transmission |
| 7 | CS₁ | A combined symbol in which |
| | | the first half of the combined |
| | | symbol is HS₁, and the |
| | | second half of the combined symbol is HS₄ |
| 8 | CS₂ | A combined symbol in which |
| | | the first half of the combined |
| | | symbol is HS₃, and the |
| | | second half of the combined symbol is HS₂ |
| 9 | CS₃ | A combined symbol in which |
| | | the first half of the combined |
| | | symbol is HS₂, and the |
| | | second half of the combined symbol is HS₁; |
| 10 | CS₄ | A combined symbol in which |
| | | the first half of the combined |
| | | symbol is HS₄, and the |
| | | second half of the combined symbol is HS₂ |

An example of sidelink slot information element (IE) is as below.
SL-SlotList::=SEQUENCE (SIZE(1..maxNrofSL-Slot)) OF SL-Slot
Note:
   (1) SL-SlotList corresponds to the information of sidelink slot configured for example in a resource pool.
   (2) SL-SlotList has a data type of SEQUENCE, which includes one or more SL-Slot.
   (3) The number of SL-Slot in a SL-SlotList can be up to maxNrofSL-Slot.
   (4) Field descriptions of “SL-Slot” are introduced in exemplary Table 3.

TABLE 3
field descriptions of “SL-Slot” in the
sidelink slot IE as described above.
SL-Slot field descriptions

sl-SlotID
This field indicates the ID for this Slot.
sl-SlotPatternID
This field indicates the ID for the pattern based on which a sidelink slot is
constructed. This field is optional. This field is only used when multiple
slot patterns are configured for the sidelink slot.
The data type of this filed can be an enumerated type. For example, “1”
and “2” may represent Embodiment 1 and Embodiment 2 as illustrated in
the embodiments of FIG. 13, respectively.
sl-Slot-SymbolList
This field indicates how a slot is constructed by an orderly set (or list) of
symbols. If sl-SlotPatternID is defined, the symbols are defined associated
with the sl-SlotPatternID. Otherwise, the symbols are defined associated
with a default type, such as the one illustrated by Embodiment 1.

An example of “sl-Slot-SymbolList” IE is as below.

sl-Slot-SymbolList ::= SEQUENCE (SIZE (1..maxNrofSymbols-In-Slot)}
OF SymbolID.

Note:
   (1) sl-Slot-SymbolList has a data type of SEQUENCE, which includes one or more SymbolID.
   (2) The number of SymbolID in sl-Slot-SymbolList can be up to maxNrofSymbols-In-Slot.
   (3) SymbolID are further described as illustrated by Table 1 or Table 2.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE), comprising:
at least one memory; and
at least one processor coupled with the at least one memory and configured to cause the UE to:
obtain configuration information regarding one or more sidelink slots, wherein each sidelink slot within the one or more sidelink slots includes multiple sets of symbols; and
transmit, via a sidelink of the UE, using the one or more sidelink slots.

2. The UE of claim 1, wherein the configuration information regarding the one or more sidelink slots includes:
a first list of one or more information elements, wherein each information element in the first list is associated with one sidelink slot within the one or more sidelink slots; and
a total number of the one or more sidelink slots.

3. The UE of claim 2, wherein each of the information elements in the first list includes at least one of:
an identifier (ID) of the one sidelink slot;
a slot pattern ID of the one sidelink slot; or
a second list of one or more information elements associated with one or more symbols within the one sidelink slot.

4. The UE of claim 3, wherein each of the information elements in the first list includes the slot pattern ID, in response to two or more slot patterns configured for the one sidelink slot.

5. The UE of claim 3, wherein the second list includes a total number of the one or more symbols, and wherein each information element in the second list includes an ID of one symbol within the one or more symbols.

6. The UE of claim 3, wherein each symbol within the one or more symbols is one of:
a full symbol;
a half symbol; or
a combined symbol, wherein the combined symbol comprises two half symbols with different types.

7. The UE of claim 1, wherein each of the sidelink slots includes one or more sub-slots, wherein each set within the multiple sets of symbols corresponds to one sub-slot within the one or more sub-slots, and the one sub-slot includes at least one of:
a full symbol;
a half symbol; or
a combined symbol, wherein the combined symbol comprises two half symbols with different types.

8. The UE of claim 6, wherein the full symbol includes at least one of a physical sidelink shared channel (PSSCH) transmission, a physical sidelink control channel (PSCCH) transmission, or a physical sidelink feedback channel (PSFCH) transmission.

9. The UE of claim 6, wherein a length of the full symbol is equal to a length of an orthogonal frequency division multiplexing (OFDM) symbol in a time domain, and wherein a starting point of the full symbol is aligned with one of:
a starting point of the OFDM symbol; or
a starting point of a second half of the OFDM symbol.

10. The UE of claim 6, wherein the half symbol includes one of:
a copy of a first half of a full symbol after the half symbol in a time domain;
a copy of a second half of a full symbol before the half symbol in the time domain;
a switching gap in the time domain between a transmission operation of the UE and a reception operation of the UE; or
information associated with a preamble sequence.

11. The UE of claim 6, wherein a length of the combined symbol is equal to a length of an orthogonal frequency division multiplexing (OFDM) symbol in a time domain.

12. The UE of claim 7, wherein a sub-slot within the one or more sub-slots is one of:
a first type of sub-slot, wherein the first type of sub-slot comprises one or more symbols carrying at least one of a physical sidelink shared channel (PSSCH) transmission or a physical sidelink control channel (PSCCH) transmission; and
a second type of sub-slot, wherein the second type of sub-slot comprises one or more symbols carrying a physical sidelink feedback channel (PSFCH) transmission.

13. The UE of claim 1, wherein the configuration information regarding the one or more sidelink slots is associated with one of:
a resource pool;
a zone; or
a frequency band.

14. The UE of claim 1, wherein, to transmit using the one or more sidelink slots, the at least one processor is configured to cause the UE to transmit, via the sidelink of the UE, using one of the one or more sidelink slots at one time instance.

15. A network node, comprising:
at least one memory; and
at least one processor coupled with the at least one memory and configured to transmit, to a user equipment (UE), configuration information regarding one or more sidelink slots, wherein each sidelink slot within the one or more sidelink slots includes multiple sets of symbols.

16. A processor for wireless communication, comprising:
at least one controller coupled with at least one memory and configured to cause the processor to:
obtain configuration information regarding one or more sidelink slots, wherein each sidelink slot within the one or more sidelink slots includes multiple sets of symbols; and
transmit via a sidelink using the one or more sidelink slots.

17. A method performed by a user equipment (UE), the method comprising:
obtaining configuration information regarding one or more sidelink slots, wherein each sidelink slot within the one or more sidelink slots includes multiple sets of symbols; and
transmitting via a sidelink of the UE using the one or more sidelink slots.

18. The method of claim 17, wherein the configuration information regarding the one or more sidelink slots includes:
a first list of one or more information elements, wherein each information element in the first list is associated with one sidelink slot within the one or more sidelink slots; and
a total number of the one or more sidelink slots.

19. The method of claim 18, wherein each of the information elements in the first list includes at least one of:
an identifier (ID) of the one sidelink slot;
a slot pattern ID of the one sidelink slot; or
a second list of one or more information elements associated with one or more symbols within the one sidelink slot.

20. The method of claim 17, wherein the each sidelink slot includes one or more sub-slots, wherein each set within the multiple sets of symbols corresponds to one sub-slot within the one or more sub-slots, and the one sub-slot includes at least one of:
a full symbol;
a half symbol; or
a combined symbol, wherein the combined symbol comprises two half symbols with different types.
